(19) United States
(12) Patent Application Publication
(10) Pub. No.: US 2025/0119883 A1
(43) Pub. Date: Apr. 10, 2025

(54) WIRELESS SENSING METHOD AND DEVICE

(71) Applicant: GUANGDONG OPPO MOBILE TELECOMMUNICATIONS CORP., LTD., Dongguan (CN)

(72) Inventors: Bin LIANG, Dongguan (CN); Jing XU, Dongguan (CN); Yi ZHANG, Dongguan (CN); Yanan LIN, Dongguan (CN)

(21) Appl. No.: 18/983,800

(22) Filed: Dec. 17, 2024

Related U.S. Application Data
(63) Continuation of application No. PCT/CN2022/100637, filed on Jun. 23, 2022.

(51) Int. Cl. H04W 72/0446; H04W 4/02

(52) U.S. Cl. CPC H04W 72/0446; H04W 4/02

(57) ABSTRACT

A method a for wireless sensing includes: determining, by a sensing device, a sensing result according to a plurality of sensing signals; where the plurality of sensing signals are received by the sensing device by adopting a first receiving manner, or the sensing result is determined by the sensing device based on a first processing manner; the first receiving manner comprises not performing waveform adjusting on a sensing signal, or the first receiving manner comprises performing waveform adjusting on a sensing signal by adopting a first waveform adjustment parameter; and the first processing manner is used for the sensing device to perform waveform correction processing on the plurality of sensing signals.

### CROSS-REFERENCE TO RELATED APPLICATION

This application is a Continuation of International Application No. PCT/CN2022/100637 filed Jun. 23, 2022, which is incorporated herein by reference in its entirety.

### TECHNICAL FIELD

Embodiments of the present application relate to the field of communication, in particular, to a method and a device for wireless sensing.

### BACKGROUND

The wireless communication and the wireless sensing are two important applications of modern radio frequency technology. The wireless sensing is to utilize a backscattered radio wave to detect a parameter of a physical environment, so as to achieve environmental sensing, such as target positioning, motion recognition, and imaging, etc. In some scenarios, a sensing device achieves sensing of a sensed object by measuring a received signal. For example, the sensing device may multiplex a hardware module for communication to realize a sensing function. In this case, how to ensure the accuracy of a sensing result is an urgent problem that needs to be solved.

### SUMMARY

In a first aspect, a method for wireless sensing is provided, and the method for wireless sensing includes: determining, by a sensing device, a sensing result according to a plurality of sensing signals;
where the plurality of sensing signals are received by the sensing device by adopting a first receiving manner, or the sensing result is determined by the sensing device based on a first processing manner; the first receiving manner includes not performing waveform adjusting on a sensing signal, or the first receiving manner includes performing waveform adjusting on a sensing signal by adopting a first waveform adjustment parameter; and the first processing manner is used for the sensing device to perform waveform correction processing on the plurality of sensing signals.

In a second aspect, a method for wireless sensing is provided, and the method for wireless sensing includes: sending, from a control device, first configuration information to a sensing device, where the first configuration information is used to configure a receiving manner adopted for the sensing device to receive a sensing signal, and the receiving manner includes not performing waveform adjusting on the sensing signal, or performing waveform adjusting on the sensing signal by adopting a waveform adjustment parameter.

In a third aspect, a sensing device is provided, where the sensing device is used to perform the method in the above-mentioned first aspect or various implementations thereof.

Specifically, the sensing device includes a functional module for performing the method in the above-mentioned first aspect or various implementations thereof.

In a fourth aspect, a control device is provided, where the control device is used to perform the method in the above-mentioned second aspect or various implementations thereof.

Specifically, the control device includes a functional module for performing the method in the above-mentioned second aspect or various implementations thereof.

In a fifth aspect, a sensing device is provided, which includes a processor and a memory. The memory is used to store a computer program, and the processor is used to invoke and execute the computer program stored in the memory, causing the sensing device to perform the method in the above-mentioned first aspect or various implementations thereof.

In a sixth aspect, a control device is provided, which includes a processor and a memory. The memory is used to store a computer program, and the processor is used to invoke and execute the computer program stored in the memory, causing the sensing device to perform the method in the above-mentioned second aspect or various implementations thereof.

In a seventh aspect, a chip is provided, which is used to implement the method in any aspect of the above-mentioned first aspect to second aspect or various implementations thereof.

Specifically, the chip includes: a processor, used to invoke and execute a computer program from a memory, causing a device equipped with the apparatus to perform the method in any aspect of the above-mentioned first aspect to second aspect or various implementations thereof.

In an eighth aspect, a non-transitory computer-readable storage medium is provided, which is used to store a computer program, where the computer program causes a computer to perform the method in any aspect of the above-mentioned first aspect to second aspect or various implementations thereof.

In a ninth aspect, a computer program product is provided, which includes a computer program instruction, where the computer program instruction causes a computer to perform the method in any aspect of the above-mentioned first aspect to second aspect or various implementations thereof.

In a tenth aspect, a computer program is provided, where when the computer program is executed on a computer, the computer is caused to perform the method in any aspect of the above-mentioned first aspect to second aspect or various implementations thereof.

### BRIEF DESCRIPTION OF THE DRAWINGS

FIG. 1 is a schematic diagram of an architecture of a communication system provided in the embodiments of the present application.

FIG. 2 is a schematic diagram of a method for wireless sensing provided according to the embodiments of the present application.

FIGS. 3 to 6 are example diagrams of a method for wireless sensing according to the embodiments of the present application.

FIG. 7 is another schematic diagram of a method for wireless sensing provided according to the embodiments of the present application.

FIG. 8 is a schematic block diagram of a sensing device provided according to the embodiments of the present application.

FIG. 9 is a schematic block diagram of a control device provided according to the embodiments of the present application.

FIG. 10 is a schematic block diagram of a communication device provided according to the embodiments of the present application.

FIG. 11 is a schematic block diagram of a chip provided according to the embodiments of the present application.

FIG. 12 is a schematic block diagram of a communication system provided according to the embodiments of the present application.

### DETAILED DESCRIPTION

The technical solutions in the embodiments of the present application will be described below in combination with the appending drawings in the embodiments of the present application. Obviously, the described embodiments are only a part of the embodiments of the present application, rather than all of the embodiments. With respect to the embodiments in the present application, all other embodiments obtained by those skilled in the art shall fall into the scope of protection of the present application.

The technical solutions of the embodiments of the present applicationapplication may be applied to various communication systems, such as: a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an Advanced long term evolution (LTE-A) system, a New Radio (NR) system, an evolution system of an NR system, an LTE-based access to unlicensed spectrum (LTE-U) system, an NR-based access to unlicensed spectrum (NR-U) system, a Non-Terrestrial communication Network (Non-Terrestrial Networks, NTN) system, a Universal Mobile Telecommunication System (UMTS), a Wireless Local Area Network (WLAN) system, a Wireless Fidelity (WiFi) system, a fifth-generation communication (5th-Generation, 5G) system, or other communication systems, etc.

Generally speaking, a number of connections supported by a traditional communication system is limited and is easy to implement, however, with the development of the communication technology, the mobile communication system will not only support the traditional communication, but also support, for example, Device to Device (D2D) communication, Machine to Machine (M2M) communication, Machine Type Communication (MTC), Vehicle to Vehicle (V2V) communication, or Vehicle to everything (V2X) communication, etc, and the embodiments of the present applicationapplication may also be applied to these communication systems.

Optionally, the communication system in the embodiments of the present applicationapplication may be applied to a carrier aggregation (CA) scenario, may also be applied to a dual connectivity (DC) scenario, and may also be applied to a standalone (SA) network deployment scenario.

Optionally, the communication system in the embodiments of the present applicationapplication may be applied to an unlicensed spectrum, where the unlicensed spectrum may also be considered as a shared spectrum; or the communication system in the embodiments of the present applicationapplication may also be applied to a licensed spectrum, where the licensed spectrum may also be considered as an unshared spectrum.

The embodiments of the present applicationapplication describe various embodiments in conjunction with a network device and a terminal device, where the terminal device may also be referred to as a user equipment (UE), an access terminal, a user unit, a user station, a mobile station, a mobile platform, a remote station, a remote terminal, a mobile device, a user terminal, a terminal, a wireless communication device, a user agent or a user apparatus, etc.

The terminal device may be a station (STATION, STA) in the WLAN, may be a cellular phone, a cordless phone, a Session Initiation Protocol (SIP) phone, a Wireless Local Loop (WLL) station, or a personal digital assistant (Personal Digital Assistant, PDA) device, a handheld device with a wireless communication function, a computing device or other processing devices connected to a wireless modem, a vehicle-mounted device, a wearable device, a terminal device in a next generation communication system such as in an NR network, or a terminal device in a Public Land Mobile Network (PLMN) network evolved in the future, etc.

In the embodiments of the present applicationapplication, the terminal device may be deployed on land, which includes indoor or outdoor, in handheld, worn or vehicle-mounted; may also be deployed on water (e.g., on a ship, etc.); may also be deployed in the air (e.g., on an airplane, a balloon, a satellite, etc.).

In the embodiments of the present applicationapplication, the terminal device may be a mobile phone, a pad, a computer with a wireless transceiving function, a Virtual Reality (VR) terminal device, an Augmented Reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, etc.

As an example but not a limitation, in the embodiments of the present applicationapplication, the terminal device may also be a wearable device. The wearable device, which is also referred to as a wearable smart device, is a generic term for a device that can be worn, into which the daily wear is intelligently designed and developed by applying wearable technologies, such as glasses, gloves, watches, clothing, and shoes, etc. The wearable device is a portable device that is worn directly on the body, or integrated into the user's clothing or accessories. The wearable device is not just a hardware device, but also achieves powerful functions through software supporting, data interaction, and cloud interaction. A generalized wearable smart device includes for example, a smartwatch or smart glasses, etc., with full functions, large size, and entire or partial functions without relying on a smartphone, as well as, for example, a smart bracelet and smart jewelry for physical sign monitoring, which only focuses on a certain type of application function and needs to be used in conjunction with other devices such as a smartphone.

In the embodiments of the present applicationapplication, the network device may be a device used for communicating with a mobile device. The network device may be an Access Point (AP) in the WLAN, a base station (Base Transceiver Station, BTS) in the GSM or CDMA, may also be a base station (NodeB, NB) in the WCDMA, or may also be an evolutional Node B (Evolutional Node B, eNB or eNodeB) in the LTE, or a relay station or an access point, or a vehicle-mounted device, a wearable device, and a network device (gNB) in an NR network, or a network device in the PLMN network evolved in the future or a network device in the NTN network, etc.

As an example but not a limitation, in the embodiments of the present applicationapplication, the network device may have a mobile characteristic, for example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station provided on land, water, and other places.

In the embodiments of the present applicationapplication, the network device may provide a service for a cell, and the terminal device communicates with the network device through a transmission resource (such as a frequency domain resource, or a frequency spectrum resource) used by the cell. The cell may be a cell corresponding to the network device (such as the base station), the cell may belong to a macro base station or may also belong to a base station corresponding to a small cell, and the small cell here may include: a metro cell, a micro cell, a pico cell, a femto cell, etc, these small cells have characteristics of small coverage range and low transmission power, which are applicable for providing a data transmission service with high speed.

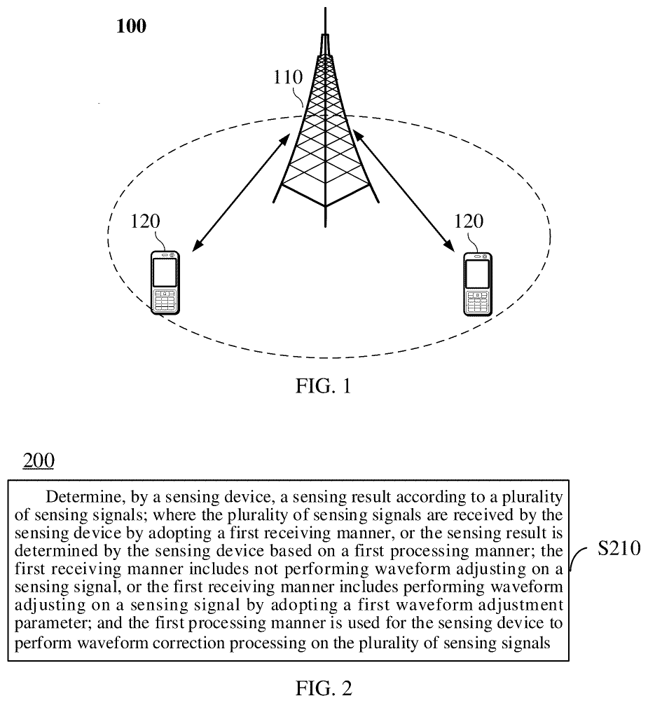

Exemplarily, a communication system 100 applied in the embodiments of the present application is as shown in FIG. 1. The communication system 100 may include a network device 110, and the network device 110 may be a device for communicating with a terminal device 120 (or referred to as a communication terminal or a terminal). The network device 110 may provide a communication coverage for a specific geographical area and may communicate with a terminal device located in the coverage area.

FIG. 1 exemplarily shows one network device and two terminal devices. Optionally, the communication system 100 may include a plurality of network devices, and other numbers of terminal devices may be included in a coverage range of each network device, which are not limited in the embodiments of the present application.

Optionally, the communication system 100 may further include other network entities, such as a network controller, a mobility management entity, etc., which are not limited in the embodiments of the present application.

It should be understood that, a device having a communication function in a network/system in the embodiments of the present application may be referred to as a communication device. Taking the communication system 100 shown in FIG. 1 as an example, the communication device may include the network device 110 and the terminal device 120 which have the communication function. The network device 110 and the terminal device 120 may be the specific devices described above, which are not repeated herein. The communication device may further include other devices in the communication system 100, for example, other network entities, such as a network controller, a mobile management entity, etc., which are not limited in the embodiments of the present application.

It should be understood that, the terms “system” and “network” herein are often used interchangeably herein. The term “and/or” herein is merely to describe an association relationship of associated objects, and represents that there may be three kinds of relationships, for example, A and/or B may mean three cases where: A exists alone, both A and B exist, and B exists alone. In addition, a character “/” herein generally means that associated objects before and after “/” are in an “or” relationship.

It should be understood that, the “indicate/indication/indicating/indicated” mentioned in the embodiments of the present application may be a direct indication, may also be an indirect indication, or may also represent having an association relationship. For example, A indicating B, may mean that A directly indicates B, for example, B may be obtained via A; may also mean that A indirectly indicates B, for example, A indicates C, and B may be obtained via C; may also mean that there is an association relationship between A and B.

In the description of the embodiments of the present application, the term “correspond/corresponding” may mean that there is a direct correspondence or indirect correspondence between two objects, or may also represent there is an association relationship between the two objects, or may also be relationships of indicating and being indicated, or configuring and being configured, etc.

In the embodiments of the present application, “predefined” may be implemented by pre-saving corresponding codes, tables, or other mannerts that may be used to indicate related information in a device (e.g., including the terminal device and the network device), specific implementation methods of which is not limited in the present application. For example, the “predefined” may be defined in a protocol.

The wireless communication and the wireless sensing are two important applications of modern radio frequency technology. The wireless sensing is to utilize a backscattered radio wave to detect a parameter of a physical environment, so as to achieve environmental sensing, such as target positioning, motion recognition, and imaging, etc. Traditional wireless sensing exists independently from the communication, as a separated design causes the waste of a wireless spectrum and a hardware resource. Since entering the era of 5G and Beyond (B5G) mobile communication system and a 6th generation (6G) mobile communication system, a spectrum for communication is moving towards millimeter wave, terahertz, and visible light for communication. A spectrum for future wireless communication will overlap with a traditional sensing spectrum. Communication and sensing technology integrates two functions of communication and sensing, wireless resource management in communication may be used to solve an interference problem in traditional wireless sensing, a widely deployed cellular network may be used to achieve a sensing business in a larger range, a base station and a plurality of terminals are used for joint sensing to achieve higher sensing accuracy, and a hardware modules for communication may be multiplexed to achieve a sensing function, thus reducing the cost. In short, the wireless sensing technology enables a future wireless communication system to have a sensing capability, and provides a foundation for the development of businesses, such as smart transportation, a smart city, a smart factory, an unmanned aerial vehicle in the future, etc.

In some scenarios, a sensing device achieves sensing for a sensed object by measuring a received signal and estimating a channel state change. In some scenarios, the sensing device achieves sensing of a sensed object by measuring a received signal. For example, the sensing device may multiplex a hardware module for communication to achieve the sensing function.

To facilitate understanding of the embodiments of the present application, the technical problem of the embodiments of the present application is described in detail.

In a communication system, a hardware module of the sensing device includes an radio frequency module and a baseband processing module. The radio frequency module is mostly used for receiving a carrier frequency signal and adjusting a waveform. The baseband processing module performs processing, such as channel estimation, decoding, etc., on a received signal after the baseband processing module demodulates the carrier frequency signal into a baseband signal.

For example, the radio frequency module may perform waveform adjusting on a received signal, so that a signal to be parsed by the baseband processing module is within a certain range of amplitude.

During a process of receiving a signal, if the radio frequency module of the sensing device may perform the waveform adjusting on a received sensing signal, a waveform adjustment parameter directly affects a range of amplitude of an output signal, and the waveform adjustment parameter may be adjusted adaptively according to different signals. If different waveform adjustment parameters are used to perform waveform adjusting on a same sensing signal, obtained channel state information will be different when the channel state information is estimated based on the sensing signal. Further, using the channel state information estimated by the sensing signal adjusted by different waveform adjustment parameters to determine a sensing result may affect the accuracy of the sensing result.

To facilitate understanding of the technical solutions of the embodiments of the present application, the technical solutions of the present application are described in detail below through specific embodiments. The following related technologies as optional solutions may be arbitrarily combined with the technical solutions of the embodiments of the present application, which all belong to the protection scope of the embodiments of the present application. The embodiments of the present application include at least part contents of the following contents.

In a first clause, a method for wireless sensing is provided, which includes:
determining, by a sensing device, a sensing result according to a plurality of sensing signals; where
the plurality of sensing signals are received by the sensing device by adopting a first receiving manner, or the sensing result is determined by the sensing device based on a first processing manner; the first receiving manner includes not performing waveform adjusting on a sensing signal, or the first receiving manner includes performing waveform adjusting on a sensing signal by adopting a first waveform adjustment parameter, and the first processing manner is used for the sensing device to perform waveform correction processing on the plurality of sensing signals.

In a second clause, according to the first clause, the first waveform adjustment parameter is carried in first information.

In a third clause, according to the second clause, the first information is further used to determine a physical resource for receiving a sensing signal and/or sequence information of the sensing signal.

In a fourth clause, according to the first clause, receiving time of the plurality of sensing signals is within a first time window, and receiving manners for sensing signals with receiving time within the first time window are the first receiving manner.

In a fifth clause, according to the fourth clause, a position of the first time window is predefined, or the position of the first time window is configured through a signaling.

In a sixth clause, according to the fifth clause, a starting position and/or a length of the first time window is predefined, or the starting position and/or the length of the first time window is configured through a signaling.

In a seventh clause, according to the fourth clause, a position of the first time window is determined according to a time domain position of at least one sensing signal of the plurality of sensing signals.

In an eighth clause, according to the seventh clause, the position of the first time window is determined according to a time domain position of a first sensing signal of the plurality of sensing signals, and the first sensing signal is a sensing signal of the plurality of sensing signals with earliest receiving time.

In a ninth clause, according to any one of the fourth to the eighth clause, a receiving manner adopted for receiving a sensing signal within the first time window is predefined; or
the receiving manner adopted for receiving the sensing signal within the first time window is configured through a signaling; or
the receiving manner adopted for receiving the sensing signal within the first time window is determined according to a position of the first time window; or,
the receiving manner adopted for receiving the sensing signal within the first time window is a receiving manner used by the sensing device at a starting moment or before the starting moment of the first time window.

In a tenth clause, according to the ninth clause, the receiving manner adopted for receiving the sensing signal within the first time window being determined according to the position of the first time window includes:
the receiving manner adopted for receiving the sensing signal within the first time window being determined according to the position of the first time window and a mapping relationship, where the mapping relationship includes a mapping relationship between a time window and a receiving manner for receiving the sensing signal.

In an eleventh clause, according to the tenth clause, the mapping relationship is predefined, or configured through a signaling.

In a twelfth clause, according to any one of the fourth to the eleventh clause, the method further includes:
receiving, by the sensing device, a plurality of sensing signals by adopting a second receiving manner within a second time window, where the second receiving manner includes not performing waveform adjusting on a sensing signal, or the second receiving manner includes performing waveform adjusting on the sensing signal by adopting a second waveform adjustment parameter; where
the first waveform adjustment parameter is the same as the second waveform adjustment parameter; or
the first waveform adjustment parameter is different from the second waveform adjustment parameter.

In a thirteenth clause, according to any one of the first to the twelfth clause, in a case where the plurality of sensing signals are received by the sensing device by adopting the first receiving manner, determining, by the sensing device, the sensing result according to the plurality of sensing signals, includes:
determining a plurality of pieces of auxiliary sensing information according to the plurality of sensing signals; and
determining the sensing result according to the plurality of pieces of auxiliary sensing information.

In a fourteenth clause, according to the first clause, the sensing result is determined by the sensing device based on the first processing manner; and
determining, by the sensing device, the sensing result according to the plurality of sensing signals, includes:
performing waveform correction processing on the plurality of sensing signals according to a waveform adjustment parameter adopted for receiving the plurality of sensing signals;
determining a plurality of pieces of auxiliary sensing information according to a plurality of sensing signals after the waveform correction processing is performed; and
determining the sensing result according to the plurality of pieces of auxiliary sensing information.

In a fifteenth clause, according to the first clause, the sensing result is determined by the sensing device based on the first processing manner; and
determining, by the sensing device, the sensing result according to the plurality of sensing signals, includes:
determining a plurality of pieces of auxiliary sensing information according to the plurality of sensing signals;
performing waveform correction processing on the plurality of pieces of auxiliary sensing information according to a waveform adjustment parameter adopted for receiving the plurality of sensing signals; and
determining the sensing result according to the plurality of pieces of auxiliary sensing information after the waveform correction processing is performed.

In a sixteenth clause, according to any one of the thirteenth to the fifteenth clause, the auxiliary sensing information includes at least one of: channel state information, latency estimation information, or frequency offset estimation information.

In a seventeenth clause, according to any one of the first to the sixteenth clause, the sensing signal is a reflected signal of a signal sent from the sensing device, or the sensing signal is sent from other devices.

In an eighteenth clause, 1 according to any one of the first to the seventeenth clause, the first waveform adjustment parameter includes at least one of the following parameters:
an automatic gain control (AGC) adjustment parameter, a carrier frequency offset (CFO) adjustment parameter, or a sampling frequency offset (SFO) adjustment parameter.

In a nineteenth clause, a method for wireless sensing is provided, which includes:
sending, from a control device, first configuration information to a sensing device, where the first configuration information is used to configure a receiving manner adopted for the sensing device to receive a sensing signal, and the receiving manner includes not performing waveform adjusting on the sensing signal, or performing waveform adjusting on the sensing signal by adopting a waveform adjustment parameter.

In a twentieth clause, according to the nineteenth clause, the first configuration information is used to configure a first waveform adjustment parameter.

In a twenty-first clause, according to the nineteenth clause or the twentieth clause, the first configuration information is used to configure at least one of:
information of at least one time window; or
a receiving manner adopted for receiving the sensing signal within the at least one time window.

In a twenty-second clause, according to the twenty-first clause, the information of the at least one time window includes at least one of:
a starting position of the at least one time window, a length of the at least one time window, or a period of the at least one time window.

In a twenty-third clause, according to the twenty-first or the twenty-second clause, the at least one time window includes a first time window and a second time window, a receiving manner for receiving a sensing signal within the first time window is a first receiving manner, and a receiving manner for receiving a sensing signal within the second time window is a second receiving manner;
the first receiving manner includes not performing waveform adjusting on the sensing signal, or the first receiving manner includes performing waveform adjusting on the sensing signal by adopting a first waveform adjustment parameter; the second receiving manner includes not performing waveform adjusting on the sensing signal, or the second receiving manner includes performing waveform adjusting on the sensing signal by adopting a second waveform adjustment parameter; and the first waveform adjustment parameter is the same as or different from the second waveform adjustment parameter.

In a twenty-fourth clause, according to any one of the nineteenth clause to the twenty-third clause, the method further includes:
sending, from the control device, second configuration information, where the second configuration information is used to determine a physical resource for receiving the sensing signal and/or sequence information of the sensing signal.

In a twenty-fifth clause, according to any one of the nineteenth to the twenty-fourth clause, the waveform adjustment parameter includes at least one of the following parameters:
an automatic gain control (AGC) adjustment parameter, a carrier frequency offset (CFO) adjustment parameter, or a sampling frequency offset (SFO) adjustment parameter.

FIG. 2 is a schematic flow chart of a method for wireless sensing 200 according to the embodiments of the present application. As shown in FIG. 2, the method 200 includes the following contents:

S210, determining, by a sensing device, a sensing result according to a plurality of sensing signals.

In some scenarios, a communication system applied in the embodiments of the present application may include a control device and a sensing device. The control device is used to configure a physical resource for receiving a sensing signal and/or sequence information of the sensing signal for the sensing device, or to schedule transmission of the sensing signal. The sensing device is used to receive a sensing signal and to perform sensing according to the received sensing signal.

In some embodiments, the sensing device may be a terminal device in a cellular system of FIG. 1; or may also be a terminal device in a WLAN system or a WiFi system, such as an STA; or may also be another terminal with a sensing requirement in a future communication system, which is not limited in the present application.

In some embodiments, the control device may be a network device in the cellular system of FIG. 1; or may also be a network device in the WLAN system or the WiFi system, such as an AP; or may also be a network device in the future communication system; or may also be another node or device with a management and control function, which is not limited in the present application.

It should be understood that the specific sensing scenarios, such as sensing whether an approaching person is alive, sensing and identifying an identity or existence of a person from a plurality of people, sensing falling or a gesture of a person, sensing an activity trajectory of a person, sensing a vital sign (e.g., breathing or heartbeat) of a person, etc, are not limited in the present application.

In some embodiments, the plurality of sensing signals may be reflected signals of signals sent from the sensing device. In other words, the plurality of sensing signals may be reflected wave signals or echo signals of signals sent from the sensing device, or may also be signals sent from other devices, e.g., the control device.

In some embodiments, the sensing device may learn of second configuration information, where the second configuration information is used to determine a physical resource for receiving a sensing signal and/or the sequence information of the sensing signal.

In some cases, in a case where the sensing signal is a reflected wave signal or an echo signal of a signal sent from the sensing device itself, the sensing device itself may learn of the physical resource for receiving the sensing signal and the sequence information of the sensing signal.

In other cases, in a case where the sensing signal is sent from other devices, the sensing device may learn of the physical resource for receiving the sensing signal and the sequence information of the sensing signal from the other devices.

Optionally, the second configuration information may be used to semi-statically configure the physical resource for receiving the sensing signal and/or the sequence information of the sensing signal.

Optionally, the second configuration information may be used to dynamically configure the physical resource for receiving the sensing signal and/or the sequence information of the sensing signal.

Optionally, the second configuration information may be used to schedule the sensing device to receive the sensing signal, and indicate the physical resource for receiving the sensing signal and/or the sequence information of the sensing signal when scheduling a reception for the sensing signal.

It should be understood that the embodiments of the present application do not limit a device for sending the second configuration information, for example, the second configuration information may be sent from the control device.

In some embodiments, the physical resource for receiving the sensing signal may include a time domain resource and/or a frequency domain resource for receiving the sensing signal.

In some embodiments, the sequence information of the sensing signal may be used for the sensing device to perform channel estimation.

In some embodiments, determining, by the sensing device, the sensing result according to the plurality of sensing signals, may include:
determining the sensing result according to all sensing signals of the plurality of sensing signals; or
determining the sensing result according to a portion of sensing signals of the plurality of sensing signals.

In some embodiments, the portion of sensing signals may be determined according to a preset rule, e.g., may be determined by selecting N sensing signals with the latest receiving time, M sensing signals with the highest signal strength, etc., where N is a positive integer and M is a positive integer.

It should be understood that in the embodiments of the present application, the plurality of sensing signals may refer to sensing signals actually received, which may be received at one time, or may be received at multiple times, and a number of times for receiving the sensing signals and a number of sensing signals received at each time are not limited in the present application. For example, three sensing signals are finally received, in which a sensing signal 1 is received by adopting a first receiving manner at a first time, a sensing signal 2 is received by adopting the first receiving manner at a second time, and a sensing signal 3 is received by adopting the first receiving manner at a third time. For another example, three sensing signals are finally received, in which a sensing signal 1 and a sensing signal 2 are received by adopting a first receiving manner at a first time, and a sensing signal 3 is received by adopting the first receiving manner at a second time. As another example, three sensing signals are finally received, in which a sensing signal 1, a sensing signal 2, and a sensing signal 3 are received by adopting a first receiving manner at a first time.

In some embodiments, the sensing device includes a radio frequency module and a baseband processing module. The radio frequency module is used for receiving a carrier frequency signal and adjusting a waveform. The baseband processing module performs processing, such as channel estimation, decoding, etc., on a received signal after the baseband processing module demodulates the carrier frequency signal into a baseband signal.

For example, the radio frequency module may perform waveform adjusting on the received signal, so that the signal to be parsed by the baseband processing module is within a certain range of amplitude.

In some embodiments, the radio frequency module may include a waveform adjustment module, and the waveform adjustment module may include at least one of the following modules: an automatic gain control (AGC) adjustment module, a carrier frequency offset (CFO) adjustment module, or a sampling frequency offset (SFO) adjustment module.

In some embodiments, AGC adjusting is used to adjust an amplitude of a signal, thus making an amplitude of the signal be within a certain range, thereby enhancing the performance of signal reception or decoding.

In some embodiments, CFO adjusting is used to correct a carrier frequency offset of a signal, thereby enhancing the performance of signal reception or decoding.

In some embodiments, SFO adjustment is used to correct a sampling frequency offset of a signal, thereby enhancing the performance of signal reception or decoding.

In the following, a specific implementation of determination of the sensing result by the sensing device according to the plurality of sensing signals is described in combination with Embodiment 1 and Embodiment 2.
Embodiment 1: the plurality of sensing signals are received by the sensing device by adopting a first receiving manner.

In some embodiments, the first receiving manner includes not performing waveform adjusting on a sensing signal, or the first receiving manner includes performing waveform adjusting on the sensing signal by adopting a first waveform adjustment parameter.

In the embodiments of the present application, the waveform adjustment parameter may include at least one of the following parameters:
an AGC adjustment parameter, a CFO adjustment parameter, or an SFO adjustment parameter.

In some embodiments, not performing the waveform adjusting on the sensing signal may refer to:
the sensing signal not passing through the waveform adjustment module in the sensing device, or
the sensing signal passing through the waveform adjustment module, but the waveform adjustment parameter configured in the waveform adjustment module making a waveform of the sensing signal output from the waveform adjustment module unchanged, e.g., by configuring the AGC adjustment parameter as 1, CFO adjustment parameter to 0, SFO adjustment parameter as 0.

Therefore, in the embodiments of the present application, the sensing device may determine the sensing result based on the plurality of sensing signals received by adopting a same receiving manner. Since the plurality of sensing signals have not been performed the waveform adjusting yet (i.e., the plurality of sensing signals are not affected by the waveform adjustment), or the same waveform adjustment parameter is used to adjust the plurality of sensing signals (i.e., the waveform adjustment parameter has the same influence on the plurality of sensing signals), the determination of the sensing result based on the plurality of sensing signals is conducive to enhancing the accuracy of the sensing result.

In some embodiments, the receiving manner adopted for the sensing device to receive the sensing signal may be predefined, or may be configured through a signaling, e.g., configured by the control device.

For example, the sensing device is predefined to not perform the waveform adjusting on the sensing signal, or the sensing device is configured to not perform the waveform adjusting on the sensing signal through a signaling.

As another example, the sensing device is predefined to perform the waveform adjusting on the sensing signal by adopting the first waveform adjustment parameter, or the sensing device is configured to perform the waveform adjusting on the sensing signal by adopting the first waveform adjustment parameter through a signaling.

In some embodiments, the sensing device may receive first configuration information from the control device, where the first configuration information is used to configure a receiving manner adopted for the sensing device to receive the sensing signal. In a specific embodiment, the first configuration information may be used to configure the sensing device to not perform the waveform adjusting on the sensing signal, or may be used to configure the sensing device to perform the waveform adjusting on the sensing signal by adopting a waveform adjustment parameter. For example, the first configuration information may be used to configure the first waveform adjustment parameter.

In some embodiments, the first waveform adjustment parameter is carried in first information.

It should be understood that the first information may be existing information, or may be newly added information. For example, the first waveform adjustment parameter may be carried in existing configuration information, or new configuration information may be added to be used for carrying the first waveform adjustment parameter.

In some embodiments, the first information may be further used to determine the physical resource for receiving the sensing signal and/or the sequence information of the sensing signal.

That is, the first waveform adjustment parameter and the physical resource for receiving the sensing signal and/or the sequence information of the sensing signal may be carried in a same piece of information. For example, the physical resource for receiving the sensing signal and/or the sequence information of the sensing signal is carried in a first information element (IE), and the first waveform adjustment parameter may be added to the first IE.

In some other embodiments, the first information is information dedicated to configuring the waveform adjustment parameter.

That is, the first waveform adjustment parameter may be carried in a single piece of information.

For example, the first waveform adjustment parameter is carried in a second IE, where the second IE does not carry other information.

In some embodiments of the present application, determining, by the sensing device, the sensing result according to the plurality of sensing signals, includes:
determining a plurality of pieces of auxiliary sensing information according to the plurality of sensing signals; and
determining the sensing result according to the plurality of pieces of auxiliary sensing information.

In some embodiments, determining the plurality of pieces of auxiliary sensing information according to the plurality of sensing signals may include:
performing processing on the plurality of sensing signals to obtain the plurality of pieces of auxiliary sensing information, where the processing may include, but not limited to, channel estimation, latency estimation, frequency offset estimation, etc. For example, the channel estimation may be performed on the plurality of sensing signals to obtain a plurality of pieces of channel state information, and/or the latency estimation may be performed on the plurality of sensing signals to obtain a plurality of pieces of latency estimation information, and/or the frequency offset estimation may be performed on the plurality of sensing signals to obtain a plurality of pieces of frequency offset estimation information, etc.

That is, the auxiliary sensing information may include, but not limited to, at least one of the channel state information, the latency estimation information, or the frequency offset estimation information.

In the following, a case where the plurality of pieces of auxiliary sensing information including a plurality of pieces of channel state information is taken as an example for description, but the present application is not limited thereto.

In some embodiments, the sensing device may perform the channel estimation on the plurality of sensing signals to obtain the plurality of pieces of channel state information. Since the plurality of sensing signals are received by adopting the same receiving manner, the waveform adjusting has no influence on the plurality of pieces of channel state information, or the waveform adjusting has a same influence on the plurality of pieces of channel state information. Therefore, the determination of the sensing result based on the plurality of pieces of channel state information is conducive to ensuring the accuracy of the sensing result.

The following describes the specific implementation of the receiving manner for the sensing signal in combination with Embodiment 1-1 and Embodiment 1-2.
Embodiment 1-1: all sensing signals are received by adopting the first receiving manner.

In other words, a usage of the first receiving manner does not correspond to a specific time period.

For example, the sensing device does not perform the waveform adjusting on all the sensing signals, or perform the waveform adjusting on all the sensing signals by adopting the first waveform adjustment parameter. In this way, in a case where the sensing device determines the sensing result according to any plurality of received sensing signals, the influence of the waveform adjusting on the sensing result may be avoided.

In some embodiments, the first receiving manner is predefined, or configured through a signaling.

In some embodiments, the first waveform adjustment parameter may be predefined, or may be configured through a signaling.

In some embodiments, the first waveform adjustment parameter may be semi-statically configured, or dynamically configured.

In some embodiments, after the first waveform adjustment parameter is configured, the sensing device may continue to use the first waveform adjustment parameter to perform the waveform adjusting on the sensing signal until a new waveform adjustment parameter is configured.

In some embodiments, the first waveform adjustment parameter may merely be applicable to sensing signals, that is, the waveform adjusting may be performed on all the sensing signals by adopting the first waveform adjustment parameter, but for other signals, the first waveform adjustment parameter may be used for the waveform adjusting, or the first waveform adjustment parameter may not be used for the waveform adjusting, which is conducive to ensuring the accuracy of the sensing results without affecting the communication performance.

In some other embodiments, the first waveform adjustment parameter may be applicable to all signals, which is not limited to the sensing signal. That is, the waveform adjusting is performed on all the signals by using the first waveform adjustment parameter. Adopting this manner is conducive to ensuring the accuracy of the sensing result, thus reducing the implementation complexity of the sensing device.

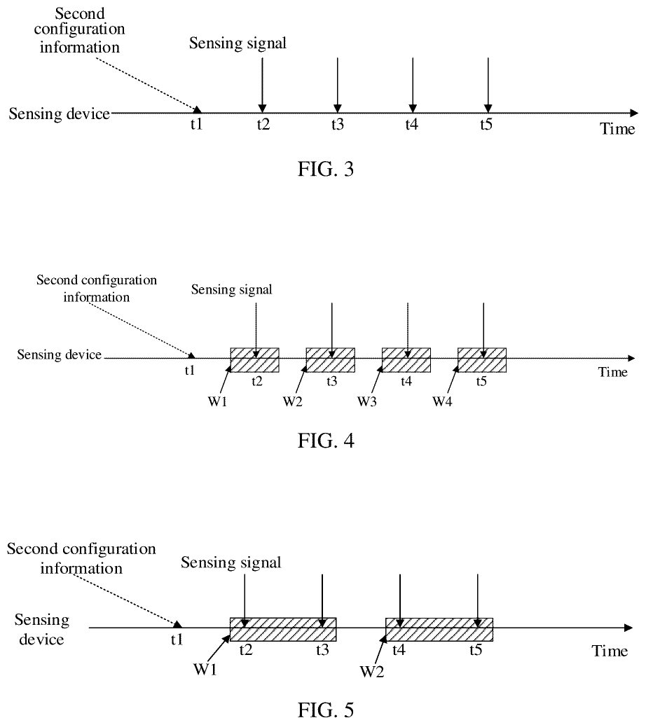

The description is illustrated by examples in combination with FIG. 3. As shown in FIG. 3, the sensing device receives second configuration information at a moment t1, and learns of the physical resource for receiving a sensing signal and/or sequence information of the sensing signal. In a case where the sensing signal is a reflected wave signal or an echo signal of a signal sent from the sensing device itself, this operation may not be included.

Optionally, when receiving sensing signals at moments t2, t3, t4 and t5, a radio frequency module of the sensing device may not perform the AGC adjusting on received signals, or when receiving signals at moments t2, t3, t4 and t5, the radio frequency module of the sensing device performs the AGC adjusting on the received signals by using a same AGC adjustment parameter.

Optionally, when receiving sensing signals at moments t2, t3, t4 and t5, the radio frequency module of the sensing device may not perform the CFO adjusting on received signals, or when receiving signals at moments t2, t3, t4 and t5, the radio frequency module of the sensing device performs the CFO adjusting on the received signals by using a same CFO adjustment parameter.

Optionally, when receiving sensing signals at moments t2, t3, t4 and t5, the radio frequency module of the sensing device may not perform the SFO adjusting on the received signals, or when receiving signals at moments t2, t3, t4 and t5, the radio frequency module of the sensing device performs the SFO adjusting on the received signals by using a same SFO adjustment parameter.

Further, the baseband processing module of the sensing device uses the received sensing signals to determine the sensing result. For example, the baseband processing module of the sensing device estimates channel state information according to the received sensing signals, and then determines the sensing result by using channel state information of sensing signals received at different moments.
Embodiment 1-2: receiving time of the plurality of sensing signals is within a first time window, where receiving manners of sensing signals with receiving time within the first time window are the first receiving manner.

In other words, a usage of the first receiving manner corresponds to a specific time period, and the first receiving manner is a receiving manner adopted in a specific time period.

Specifically, within one time window, the sensing device does not perform the waveform adjusting on the sensing signals received within the time window, or adopts a same waveform adjustment parameter to perform the waveform adjusting. That is, the same receiving manner is adopted to receive the sensing signals within one time window.

Compared with the aforementioned Embodiment 1-1, a finer-granularity control of receiving manner (or waveform adjustment parameter) may be implemented in Embodiment 1-2, which is conducive to enhancing the reception performance of the sensing signal.

In some embodiments, in a case where the sensing signal is an echo signal or a reflected wave signal of a signal sent from a sensing device, the sensing device may not perform the waveform adjusting on all received signals or maintain the same waveform adjustment parameter within a period of time (e.g., a first time window) after sending the signal. Further, the sensing device receives a plurality of echo signals or reflected wave signals of the signal sent by the sensing device within this time window, and performs sensing according to the plurality of echo signals or reflected wave signals. Since the plurality of echo signals or reflected wave signals are received by using the same receiving manner, it is conducive to reducing the inference of the waveform adjusting on the sensing result.

In some embodiments, the first receiving manner (e.g., the first waveform adjustment parameter) may merely be applicable to sensing signals within the first time window, that is, the first receiving manner (e.g., the first waveform adjustment parameter) is used to receive all sensing signals within the first time window, but the first receiving manner may be used or not used to receive other signals, which is conducive to ensuring the accuracy of the sensing result without affecting the communication performance.

In some embodiments, the first receiving manner (e.g., the first waveform adjustment parameter) may be applicable to all signals, not limited to the sensing signals within a first time window. That is, the first receiving manner (e.g., the first waveform adjustment parameter) is used to receive all the signals, which is conducive to ensuring the accuracy of the sensing result, thus reducing the implementation complexity of the sensing device.

In some embodiments, a position of the first time window is predefined, or configured through a signaling.

In some embodiments, a starting position and/or a length of the first time window is predefined.

In some embodiments, the starting position and/or the length of the first time window is configured through a signaling.

In some embodiments, the position of the first time window is determined according to a time domain position of at least one sensing signal of the plurality of sensing signals.

In some embodiments, the starting position of the first time window is determined according to a time domain position of a first sensing signal of the plurality of sensing signals, where the first sensing signal is a sensing signal of the plurality of sensing signals with the earliest receiving time.

In some embodiments, an ending position of the first time window is determined according to a time domain position of a second sensing signal of the plurality of sensing signals, where the second sensing signal is a sensing signal of the plurality of sensing signals with the latest receiving time.

In some embodiments, the position of the first time window is determined by taking a time domain position of a sensing signal as a reference point.

For example, the starting position of the first time window may be a moment of a first time interval before the first sensing signal is sent.

For example, the ending position of the first time window may be a moment of a second time interval after the second sensing signal is sent.

Optionally, the first time interval may be predefined or configured through a signaling.

Optionally, the second time interval may be predefined or configured through a signaling.

In some other embodiments, the position of the first time window is determined according to receiving time of the second configuration information. For example, the position of the first time window takes a time for receiving the second configuration information as a reference point, which is a moment of a third time interval after the configuration information is received, and a length of the third time interval is a first duration.

Optionally, the third time interval and the first duration may be predefined or configured through a signaling.

In yet other embodiments, location information of the first time window is carried in the second configuration information.

In some embodiments, the first time window is periodic or disposable.

Optionally, a number of periods of the first time window may be finite or may also be infinite.

That is, the sensing signals are received by adopting the first receiving manner in a finite number of first time windows or an infinite number of first time windows.

In some embodiments, a period of the first time window is predefined or configured through a signaling.

In some embodiments, the number of periods of the first time window is predefined or configured through a signaling.

In some embodiments, the receiving manner (i.e., the first receiving manner) adopted for receiving the sensing signal within the first time window is predefined.

In some other embodiments, the receiving manner (i.e., the first receiving manner) adopted for receiving the sensing signal within the first time window is configured through a signaling.

In yet other embodiments, the receiving manner (i.e., the first receiving manner) adopted for receiving the sensing signal within the first time window is determined according to the position of the first time window.

Optionally, the position of the first time window may be represented by a time domain position (e.g., a time slot, etc.) where the first time window is located, or may be represented by a sequence number of the first time window.

Optionally, sequence numbers of time windows may be numbered sequentially according to time domain positions where the time windows are located.

Optionally, the sequence numbers of the time windows may be numbered sequentially starting from a first time window after the second configuration information is received.

In some embodiments, there is a mapping relationship between a time window and a receiving manner for receiving a sensing signal. Therefore, the sensing device may determine the receiving manner adopted for receiving the sensing signal within the first time window according to the position of the first time window and the mapping relationship.

In some embodiments, the mapping relationship is predefined or configured through a signaling.

Optionally, in the mapping relationship, receiving manners (or waveform adjustment parameters) corresponding to different time windows may be the same or may be different.

In some embodiments, a target waveform adjustment parameter may be determined from a plurality of candidate waveform adjustment parameters according to the position of the first time window. For example, a number of the plurality of candidate waveform adjustment parameters is performed a modulo operation according to the time domain position or sequence number of the first time window to determine the target waveform adjustment parameter.

For example, the plurality of candidate waveform adjustment parameters include K waveform adjustment parameters, and a waveform adjustment parameter corresponding to an (M)-th time window may be an (M mod K)-th waveform adjustment parameter.

In some embodiments, a receiving manner (i.e., the first receiving manner) adopted for receiving the sensing signal within the first time window is a receiving manner used by the sensing device at a starting moment or before the starting moment of the first time window.

In some embodiments, a waveform adjustment parameter adopted by the sensing device at the starting moment or before the starting moment of the first time window may be determined according to a situation and configuration of the sensing device receiving the signal at the starting moment or before the starting moment. For example, the waveform adjustment parameter may be adaptively adjusted according to information, such as a bandwidth, an amplitude, an expected amplitude, etc., of a received signal.

Therefore, in this embodiment, the waveform adjustment parameter is adaptively adjusted with a granularity of a time window, which is conducive to enhancing the performance of signal reception or decoding.

In some embodiments, the same receiving manner (e.g., a waveform adjustment parameter) is adopted to receive sensing signals within different time windows.

In a case where the same receiving manner is adopted to receive the sensing signals in different time windows, even if the sensing device determines the sensing result according to sensing signals received within different time windows, the accuracy of the sensing result can be ensured.

In some embodiments, different receiving manners (e.g., waveform adjustment parameters) are adopted to receive the sensing signals within different time windows.

In a case where different receiving manners are adopted to receive the sensing signals in different time windows, the sensing device may determine the sensing result according to the sensing signal received within a same time window, and the waveform adjustment parameters adopted for receiving the sensing signals within different time windows are adaptively adjusted based on a signal reception situation, which is conducive to ensuring the reception performance of the signals within one time window.

In some embodiments of the present application, the method 200 further includes:
receiving, by the sensing device, a plurality of sensing signals by adopting a second receiving manner within a second time window.

In some embodiments, the first receiving manner may be the same as or different from the second receiving manner.

In some embodiments, the second receiving manner includes not performing waveform adjusting on a sensing signal, or the second receiving manner includes performing waveform adjusting on a sensing signal by adopting a second waveform adjustment parameter.

In some embodiments, the first waveform adjustment parameter may be the same as or different from the second waveform adjustment parameter.

In the following, description is illustrated by examples in combination with FIG. 4 and FIG. 5. As shown in FIG. 4 and FIG. 5, a sensing device receives second configuration information at moment t1 and learns of a physical resource for receiving a sensing signal and/or sequence information of the sensing signal. In a case where the sensing signal is a reflected wave signal or an echo signal of a signal sent from the sensing device itself, this operation may not be included.

In some cases, as shown in FIG. 4, the sensing device determines time windows W1, W2, W3 and W4. For example, the time windows W1, W2, W3 and W4 may be determined according to a time domain position of a sensing signal in the second configuration information. For example, a time window starts at time x1 before the sensing signal arrives and ends at time x2 after the sensing signal arrives, where x1 and x2 are values greater than or equal to 0. Alternatively, the second configuration information may also directly carry information of the time window, such as a starting position and a length, a period, etc. The arrival time of the sensing signal may be time in which the physical resource for receiving the sensing signal configured by the second configuration information is located; or may be actual arrival time of the sensing signal, where the actual arrival time of the sensing signal may be the same as the time in which the physical resource for receiving the sensing signal is located, or there may be a certain deviation between the actual arrival time of the sensing signal and the time in which the physical resource for receiving the sensing signal is located.

In this example, a same receiving manner may be adopted to receive sensing signals by the sensing device within the time windows W1, W2, W3 and W4.

For example, within the time windows W1, W2, W3 and W4, a radio frequency module of the sensing device does not perform AGC adjusting on sensing signals, or when signals are received within the time windows W1, W2, W3 and W4, a same AGC adjustment parameter is used to perform the AGC adjusting on the sensing signals.

Optionally, within the time windows W1, W2, W3 and W4, the radio frequency module of the sensing device does not perform CFO adjusting on sensing signals, or when signals are received within the time windows W1, W2, W3 and W4, a same CFO adjustment parameter is used to perform the CFO adjusting on the sensing signals.

Optionally, within the time windows W1, W2, W3 and W4, the radio frequency module of the sensing device does not perform SFO adjusting on sensing signals, or when signals are received within the time windows W1, W2, W3 and W4, a same SFO adjustment parameter is used to perform the SFO adjusting on sensing signals.

Further, a baseband processing module of the sensing device uses a received sensing signal to estimate channel state information, and then uses channel state information of sensing signals received at different moments to determine a sensing result.

In some cases, as shown in FIG. 5, the sensing device determines the time windows W1 and W2. The time windows W1 and W2 may be determined according to the second configuration information, or the second configuration information may also directly carry information of a time window, such as a starting position, a length, a period, a number of continuous periods, etc.

In this example, a same receiving manner is adopted by the sensing device to receive sensing signals within the time windows W1 and W2, or receiving manners independent from each other are adopted by the sensing device to receive the sensing signals within the time windows W1 and W2. The independent receiving manners may be the same as or different from each other.

For example, within the time windows W1 and W2, the radio frequency module of the sensing device does not perform AGC adjusting on sensing signals, or when signals are received within the time windows W1 and W2, a same AGC adjustment parameter is used, or when the signals are received within the time windows W1 and W2, AGC adjustment parameters independent from each other are used, where the AGC adjustment parameters used within the time windows W1 and W2 may be the same as or different from each other.

Optionally, within the time windows W1 and W2, the radio frequency module of the sensing device does not perform CFO adjusting on sensing signals; or when signals are received within the time windows W1 and W2, a same CFO adjustment parameter is used; or, when the signals are received within the time windows W1 and W2, AGC adjustment parameters independent from each other are used, where the CFO adjustment parameters used within the time windows W1 and W2 may be the same as or different from each other.

Optionally, within the time windows W1 and W2, the radio frequency module of the sensing device does not perform SFO adjusting on sensing signals; or when signals are received within the time windows W1 and W2, a same SFO adjustment parameter is used; or when the signals are received within the time windows W1 and W2, AGC adjustment parameters independent from each other are used, where the SFO adjustment parameters used within the time windows W1 and W2 may be the same as or different from each other.

Further, the baseband processing module of the sensing device uses a received sensing signal to estimate channel state information, and then uses channel state information of sensing signals received at different moments to perform sensing.
Embodiment 2: the sensing result is determined by the sensing device based on a first processing manner.

Herein, the first processing manner is used for the sensing device to perform waveform correction processing on a plurality of sensing signals.

In some embodiments, the sensing device performs the waveform correction processing (or referred as to inverse waveform adjustment processing) on the plurality of sensing signals based on the first processing manner, so as to eliminate or reduce the influence on waveforms of the sensing signals caused by reception of the sensing signals by adopting a waveform adjustment parameter.

Therefore, in the embodiments of the present application, when determining the sensing result according to the plurality of sensing signals, the sensing device performs the waveform correction processing on the plurality of sensing signals to eliminate or reduce the influence on waveforms of the sensing signals caused by reception of the sensing signals by adopting a waveform adjustment parameter, and further determines the sensing result based on the sensing signals after the waveform correction processing is performed, which is conducive to enhancing the accuracy of the sensing result.

In some embodiments, performing, by the sensing device, the waveform correction processing on the plurality of sensing signals based on the first processing manner, may include:
performing, by the sensing device, the waveform correction processing on a plurality of sensing signals received through incompletely same receiving manners based on the first processing manner. It could be understood that in a case where the plurality of sensing signals are received through the incompletely same receiving manners (e.g., incompletely same waveform adjustment parameters), the influence on the plurality of sensing signals caused by the incompletely same receiving manners is not completely the same. At this time, performing sensing directly based on the plurality of sensing signals may affect the accuracy of the sensing result.

Therefore, in the embodiments of the present application, when the sensing device receives the plurality of sensing signals through the incompletely same receiving manners, the first processing manner may be adopted by the sensing device to correct the plurality of sensing signals, so as to eliminate the influence of the incompletely same receiving manners on the sensing result, and the sensing result is further determined based on the sensing signals after the waveform correction processing is performed, which is conducive to enhancing the accuracy of the sensing result.

In some other embodiments, regardless of whether the receiving manners for the plurality of sensing signals are the same, the sensing device performs the correction processing on the plurality of sensing signals based on the first processing manner.

In some embodiments, the sensing device determining the sensing result by adopting the first processing manner on the received sensing signals may be predefined, or may be configured through a signaling, such as configured by a control device.

In some embodiments, the sensing device may receive third configuration information from the control device, where the third configuration information is used to configure the sensing device adopting the first processing manner to determine the sensing result.

In some embodiments, the sensing device may learn of a receiving manner (e.g., a waveform adjustment parameter) corresponding to each of the plurality of sensing signals, so that the sensing device may perform waveform correction processing, or in other words, inverse waveform adjustment processing, on the plurality of sensing signals according to receiving manners corresponding to the plurality of sensing signals, respectively, to eliminate the influence on the waveforms of the sensing signals caused by different receiving manners.

In some embodiments of the present application, the method 200 further includes:
notifying, by the radio frequency module of the sensing device, the baseband processing module of a receiving manner used for the radio frequency module to receive a sensing signal.

For example, the baseband processing module is notified whether the radio frequency module performs waveform adjusting on the sensing signal when the radio frequency module receives a sensing signal, or the baseband processing module is notified of a waveform adjustment parameter adopted for preforming waveform adjusting on the sensing signal.

Optionally, the radio frequency module of the sensing device may indicate a receiving manner adopted for receiving the sensing signal through a signaling, for example, may indicate that no waveform adjusting is performed on the sensing signal, or indicate a specific waveform adjustment parameter, or indicate an index value of the waveform adjustment parameter, where there is a corresponding relationship between the index value and the waveform adjustment parameter.

Further, the baseband processing module of the sensing device may perform the waveform correction processing on the plurality of sensing signals based on the receiving manners corresponding to the plurality of sensing signals, so as to eliminate the influence of different receiving manners on the waveforms of the sensing signals.

In some embodiments, determining, by the sensing device, the sensing result according to the plurality of sensing signals, includes:
performing the waveform correction processing on the plurality of sensing signals according to a waveform adjustment parameter adopted for receiving the plurality of sensing signals;
determining a plurality of pieces of auxiliary sensing information according to a plurality of sensing signals after the waveform correction processing is performed; and
determining the sensing result according to the plurality of pieces of auxiliary sensing information.

That is, in this implementation, the sensing device may first perform the waveform correction processing based on a waveform adjustment parameter adopted for receiving the sensing signals, to eliminate the influence of the waveform adjusting, and then determine the sensing result according to corrected sensing signals. For example, firstly, the plurality of pieces of auxiliary sensing information is determined according to a plurality of corrected sensing signals, and further the sensing result is determined according to the plurality of pieces of auxiliary sensing information.

In some other embodiments, determining, by the sensing device, the sensing result according to the plurality of sensing signals, includes:
determining a plurality of pieces of auxiliary sensing information according to the plurality of sensing signals;
performing waveform correction processing on the plurality of pieces of auxiliary sensing information according to a waveform adjustment parameter adopted for receiving the plurality of sensing signals; and
determining the sensing result according to the plurality of pieces of auxiliary sensing information after the waveform correction processing is performed.

That is, in this implementation, the sensing device may first determine the plurality of pieces of auxiliary sensing information based on a plurality of received sensing signals, further correct the plurality of pieces of auxiliary sensing information based on the waveform adjustment parameter adopted for receiving the plurality of sensing signals, to eliminate the influence of the waveform adjustment, and further determine the sensing result based on corrected auxiliary sensing information.

In some embodiments, the auxiliary sensing information may be obtained by processing a sensing signal, where the processing may include, but not limited to, channel estimation, latency estimation, or frequency offset estimation, etc. Accordingly, the auxiliary sensing information may include, but not limited to, at least one of channel state information, latency estimation information, or frequency offset estimation information. The following description takes the auxiliary sensing information being channel state information as an example, but the present application is not limited thereto.

In some embodiments, the plurality of pieces of auxiliary sensing information include a plurality of pieces of channel state information.

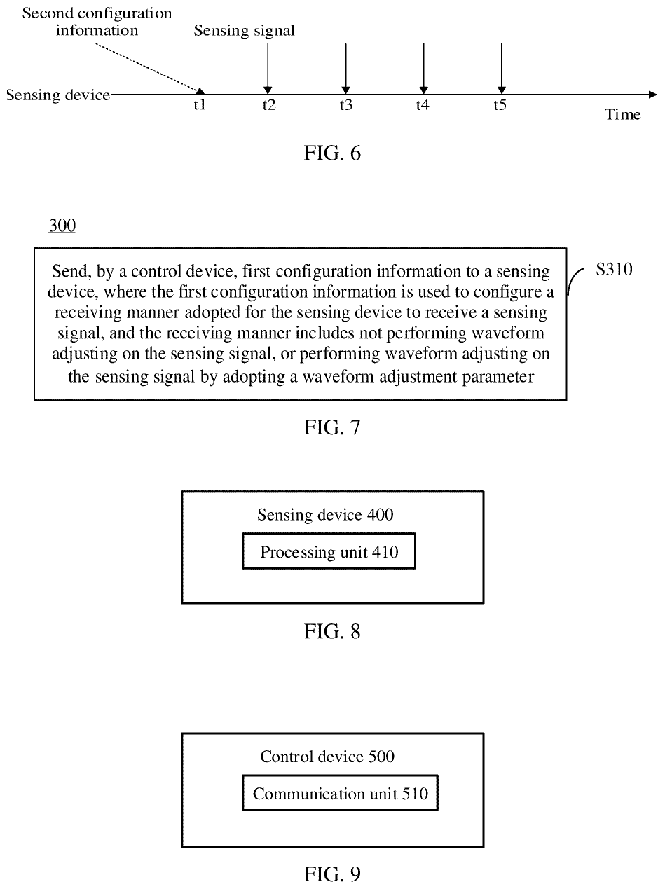

In the following, description is illustrated by examples in connection with FIG. 6. As shown in FIG. 6, the sensing device receives second configuration information at a moment t1 and learns of a physical resource for receiving a sensing signal and/or sequence information of the sensing signal. In a case where the sensing signal is a reflected wave signal or an echo signal of a signal sent from the sensing device itself, this operation may not be included.

Optionally, at a moment t2 for receiving a sensing signal, a radio frequency module of the sensing device informs a baseband processing module of an AGC adjustment parameter used to perform AGC adjusting on the sensing signal, and similar operations are performed at moments t3, t4 and t5.

Optionally, at a moment t2 for receiving a sensing signal, the radio frequency module of the sensing device informs the baseband processing module of a CFO adjustment parameter used to perform CFO adjusting on the sensing signal, and similar operations are performed at moments t3, t4 and t5.

Optionally, at time t2 for receiving a sensing signal, the radio frequency module of the sensing device informs the baseband processing module of an SFO adjustment parameter used to perform SFO adjusting on the sensing signal, and similar operations are performed at moments t3, t4 and t5.

In some cases, when the baseband processing module performs signal processing on a received sensing signal, the baseband processing module may first eliminate the influence of the AGC adjustment parameter and/or the CFO adjustment parameter and/or the SFO adjustment parameter, then perform channel estimation, and further determine a sensing result according to channel state information of sensing signals received at different moments. For example, if the radio frequency module informs the baseband processing module that the AGC adjustment parameter used for a first received sensing signal is a1, assuming that an amplitude of the first received sensing signal is y1, then an amplitude of a sensing signal reaching the baseband processing module is y=y1*a1. When the baseband processing module performs the channel estimation, the amplitude of the sensing signal y may be first corrected to y1, and then the channel estimation is performed to obtain channel state information h1 corresponding to the first sensing signal. And so forth, similar processing is performed on the second to fourth sensing signals to obtain channel state information h2, h3 and h4 sequentially. Further, sensing is performed by comparing h1, h2, h3 and h4.

In some other cases, the baseband processing module first uses a received sensing signal to perform channel estimation, then corrects estimated channel state information to eliminate the influence of the AGC adjustment parameter and/or the CFO adjustment parameter and/or the SFO adjustment parameter, and further uses corrected channel state information to perform sensing. For example, the radio frequency module informs the baseband processing module that an AGC adjustment parameter used for a first received sensing signal is a1, assuming that an amplitude of the first received sensing signal is y1, then an amplitude of the sensing signal reaching the baseband processing module is y=y1*a1. The baseband processing module uses y to perform the channel estimation to obtain corresponding channel state information h1′. And so forth, similar processing is performed on the second to fourth sensing signals to obtain channel state information h2′, h3′ and h4′ sequentially, where the AGC adjustment parameters corresponding to the three sensing signals are a2, a3, and a4, respectively. When using the channel state information to perform sensing, the sensing device may first correct the channel state information, e.g., correct the channel state information corresponding to the four sensing signals to h1′/a1, h2′/a2, h3′/a3, and h4′/a4, respectively. Further, sensing is performed by comparing the corrected channel state information h1′/a1, h2′/a2, h3′/a3, and h4′/a4.

It should be understood that in the embodiments of the present application, configuring through a signaling may refer to configuring through any signaling (e.g., the any signaling may be an existing signaling, or may also be a newly added signaling) between the sensing device and a configuration device (e.g., the control device), a which is not limited in the present application.

As an example, the sensing device is a terminal device in a cellular communication system, and the control device is a network device in the cellular communication system. The above-mentioned configuring through the signaling may refer to configuring through a downlink signaling, and the downlink signaling may include a radio resource control (RRC) signaling, downlink control information (DCI), media access control control element (MAC CE), etc.

As another example, the sensing device is an STA in a WIFI system or a WLAN system, and the control device is an AP in the WIFI system or the WLAN system. The above-mentioned configuring through the signaling may refer to configuring through a wireless frame (e.g., a management frame) in 802.11 technology.

In summary, in the embodiments of the present application, the sensing device may determine the sensing result based on the plurality of sensing signals received by adopting a same receiving manner. Since the plurality of sensing signals have not been performed waveform adjusting yet, or a same waveform adjustment parameter is used (i.e., the waveform adjustment parameter has the same influence on the plurality of sensing signals) for the waveform adjusting on the the plurality of sensing signals, determining the sensing result based on the plurality of sensing signals is conducive to enhancing the accuracy of the sensing result.

Alternatively, when the sensing device determines the sensing result based on the plurality of sensing signals, the sensing device may perform waveform correction processing on the plurality of sensing signals to eliminate or reduce the influence on waveforms of sensing signals caused by reception of the sensing signals by adopting a waveform adjustment parameter, and further determine the sensing result based on the sensing signals after the waveform correction processing is performed, which is conducive to enhancing the accuracy of the sensing result.

The above, in combination with FIGS. 2 to 6, describes in detail the methods for wireless sensing according to the embodiments of the present application from the perspective of the sensing device. The following, in combination with FIG. 7, describes in detail the method for wireless sensing according to another embodiment of the present application from the perspective of the control device. It should be understood that the description on the control device side corresponds to the description on the sensing device side. Similar descriptions can be referred to the above, which will not be repeated herein to avoid the repetition.

FIG. 7 is another schematic flowchart of a method for wireless sensing 300 according to an embodiment of the present application. As shown in FIG. 7, the method 300 includes the following contents:

S310, sending, from a control device, first configuration information to a sensing device, where the first configuration information is used to configure a receiving manner adopted for the sensing device to receive a sensing signal, and the receiving manner includes not performing waveform adjusting on the sensing signal, or performing waveform adjusting on the sensing signal by adopting a waveform adjustment parameter.

In some embodiments, the first configuration information is used to configure a first waveform adjustment parameter, where the first waveform adjustment parameter is used to perform waveform adjusting on all sensing signals.

In some embodiments, the first configuration information is used to configure at least one of:
information of at least one time window, and a receiving manner adopted for receiving a sensing signal within the at least one time window.

In some embodiments, the information of the at least one time window includes at least one of:
a starting position of the at least one time window, a length of the at least one time window, and a period of the at least one time window.

In some embodiments, the at least one time window includes a first time window and a second time window, where a receiving manner used for receiving a sensing signal within the first time window is a first receiving manner, and a receiving manner used for receiving a sensing signal within the second time window is a second receiving manner;
where the first receiving manner includes not performing waveform adjusting on the sensing signal, or the first receiving manner includes performing waveform adjusting on the sensing signal by adopting a first waveform adjustment parameter; the second receiving manner includes not performing waveform adjusting on the sensing signal, or the second receiving manner includes performing waveform adjusting on the sensing signal by adopting a second waveform adjustment parameter; and the first waveform adjustment parameter is the same as or different from the second waveform adjustment parameter.

In some embodiments, the method 300 further includes:
sending, from the control device, second configuration information, where the second configuration information is used to determine a physical resource for receiving the sensing signal and/or sequence information of a sensing signal.

In some embodiments, the first configuration information and the second configuration information are sent through a same signaling, or may be sent through different signalings.

In some embodiments, the waveform adjustment parameter includes at least one of the following parameters:
an automatic gain control (AGC) adjustment parameter, a carrier frequency offset (CFO) adjustment parameter, or a sampling frequency offset (SFO) adjustment parameter.

The above, in combination with FIGS. 2 to 7, describes in detail the method embodiments of the present application. The following, in combination with FIGS. 8 to 12, describes in detail the device embodiments of the present application. It should be understood that the device embodiments correspond to the method embodiments, and similar description may be referred to the method embodiments.

FIG. 8 shows a schematic block diagram of a sensing device 400 according to the embodiments of the present application. As shown in FIG. 8, the sensing device 400 includes:
a processing unit 410 configured to determine a sensing result according to a plurality of sensing signals;
the plurality of sensing signals are received by the sensing device by adopting a first receiving manner, or the sensing result is determined by the sensing device based on a first processing manner; the first receiving manner includes not performing waveform adjusting on a sensing signal, or the first receiving manner includes performing waveform adjusting on a sensing signal by adopting a first waveform adjustment parameter, and the first processing manner is used for the sensing device to perform waveform correction processing on the plurality of sensing signals.

In some embodiments, the first waveform adjustment parameter is carried in first information.

In some embodiments, the first information is further used to determine a physical resource for receiving the sensing signal and/or sequence information of the sensing signal.

In some embodiments, receiving time of the plurality of sensing signals is within a first time window, where receiving manners for sensing signals with receiving time within the first time window are the first receiving manner.

In some embodiments, a position of the first time window is predefined; or
the position of the first time window is configured through a signaling.

In some embodiments, a starting position and/or a length of the first time window is predefined; or
the starting position and/or the length of the first time window is configured through a signaling.

In some embodiments, the position of the first time window is determined according to a time domain position of at least one sensing signal of the plurality of sensing signals.

In some embodiments, the position of the first time window is determined according to a time domain position of a first sensing signal of the plurality of sensing signals, where the first sensing signal is a sensing signal of the plurality of sensing signals with the earliest receiving time.

In some embodiments, the receiving manner adopted for receiving the sensing signal within the first time window is predefined; or
the receiving manner adopted for receiving the sensing signal within the first time window is configured through a signaling; or
the receiving manner adopted for receiving the sensing signal within the first time window is determined according to the position of the first time window; or,
the receiving manner adopted for receiving the sensing signal within the first time window is a receiving manner used by the sensing device at a starting moment or before the starting moment of the first time window.

In some embodiments, the receiving manner adopted for receiving the sensing signal within the first time window being determined according to the position of the first time window, includes:
the receiving manner adopted for receiving the sensing signal within the first time window being determined according to the position of the first time window and a mapping relationship, where the mapping relationship includes a mapping relationship between a time window and a receiving manner for receiving a sensing signal.

In some embodiments, the mapping relationship is predefined or configured through a signaling.

In some embodiments, the sensing device 400 further includes:
a communication unit (not shown), configured to receive a plurality of sensing signals by adopting a second receiving manner within a second time window, where the second receiving manner includes not performing waveform adjusting on a sensing signal, or the second receiving manner includes performing waveform adjusting on a sensing signal by adopting a second waveform adjustment parameter;
the first waveform adjustment parameter is the same as the second waveform adjustment parameter; or
the first waveform adjustment parameter is different from the second waveform adjustment parameter.

In some embodiments, in a case where the plurality of sensing signals are received by the sensing device in the first receiving manner, the processing unit 410 is further configured to:
determine a plurality of pieces of auxiliary sensing information according to the plurality of sensing signals; and
determine the sensing result according to the plurality of pieces of auxiliary sensing information.

In some embodiments, the sensing result is determined by the sensing device based on the first processing manner, and the processing unit 410 is further configured to:
perform waveform correction processing on the plurality of sensing signals according to a waveform adjustment parameter adopted for receiving the plurality of sensing signals;
determine a plurality of pieces of auxiliary sensing information according to a plurality of sensing signals after the waveform correction processing is performed; and
determine the sensing result according to the plurality of pieces of auxiliary sensing information.

In some embodiments, the sensing result is determined by the sensing device based on the first processing manner, and the processing unit 410 is further configured to:
determine a plurality of pieces of auxiliary sensing information according to the plurality of sensing signals;
perform waveform correction processing on the plurality of pieces of auxiliary sensing information according to a waveform adjustment parameter adopted for receiving the plurality of sensing signals; and
determine the sensing result according to the plurality of pieces of auxiliary sensing information after the waveform correction processing is performed.

In some embodiments, the auxiliary sensing information includes at least one of: channel state information, latency estimation information, or frequency offset estimation information.

In some embodiments, the sensing signal is a reflected signal of a signal sent from the sensing device, or the sensing signal is sent from other devices.

In some embodiments, the first waveform adjustment parameter includes at least one of the following parameters:
an automatic gain control (AGC) adjustment parameter, a carrier frequency offset (CFO) adjustment parameter, or a sampling frequency offset (SFO) adjustment parameter.

Optionally, in some embodiments, the above-mentioned communication unit may be a communication interface or a transceiver, or an input/output interface of a communication chip or a system on chip. The above-mentioned processing unit may be one or more processors.

It should be understood that the sensing device 400 according to the embodiments of the present application may correspond to the terminal device in the method embodiments of the present application, and the above-mentioned and other operations and/or functions of various units in the sensing device 400 are for realizing the corresponding procedures of the terminal device in the method 200 shown in FIGS. 2 to 6, respectively, which will not be repeated herein for the sake of brevity.

FIG. 9 is a schematic block diagram of a control device according to the embodiments of the present application. The control device 500 of FIG. 9 includes:
a communication unit 510 configured to send first configuration information to a sensing device, where the first configuration information is used to configure a receiving manner adopted for the sensing device to receive a sensing signal, and the receiving manner includes not performing waveform adjusting on the sensing signal, or performing waveform adjusting on the sensing signal by adopting a waveform adjustment parameter.

In some embodiments, the first configuration information is used to configure a first waveform adjustment parameter.

In some embodiments, the first configuration information is used to configure at least one of:
information of at least one time window; and
a receiving manner adopted for receiving a sensing signal within the at least one time window.

In some embodiments, the information of the at least one time window includes at least one of:
a starting position of the at least one time window, a length of the at least one time window, and a period of the at least one time window.

In some embodiments, the at least one time window includes a first time window and a second time window, where a receiving manner for receiving a sensing signal within the first time window is a first receiving manner, and a receiving manner for receiving a sensing signal within the second time window is a second receiving manner;
the first receiving manner includes not performing waveform adjusting on the sensing signal, or the first receiving manner includes performing waveform adjusting on the sensing signal by adopting a first waveform adjustment parameter; the second receiving manner includes not performing waveform adjusting on the sensing signal, or the second receiving manner includes performing waveform adjusting on the sensing signal by adopting a second waveform adjustment parameter; and the first waveform adjustment parameter is the same as or different from the second waveform adjustment parameter.

In some embodiments, the communication unit 510 is further configured to:
send second configuration information, where the second configuration information is used to determine a physical resource for receiving a sensing signal and/or sequence information of the sensing signal.

In some embodiments, the waveform adjustment parameter includes at least one of the following parameters:
an automatic gain control (AGC) adjustment parameter, a carrier frequency offset (CFO) adjustment parameter, or a sampling frequency offset (SFO) adjustment parameter.

Optionally, in some embodiments, the above-mentioned communication unit may be a communication interface or a transceiver, or an input/output interface of a communication chip or a system on chip.

It should be understood that the control device 500 according to the embodiments of the present application may correspond to the control device in the method embodiments of the present application, and the above-mentioned and other operations and/or functions of various units in the control device 500 are for realizing the corresponding procedures of the control device in the methods shown in FIGS. 2 to 7, respectively, which will not be repeated herein for the sake of brevity.

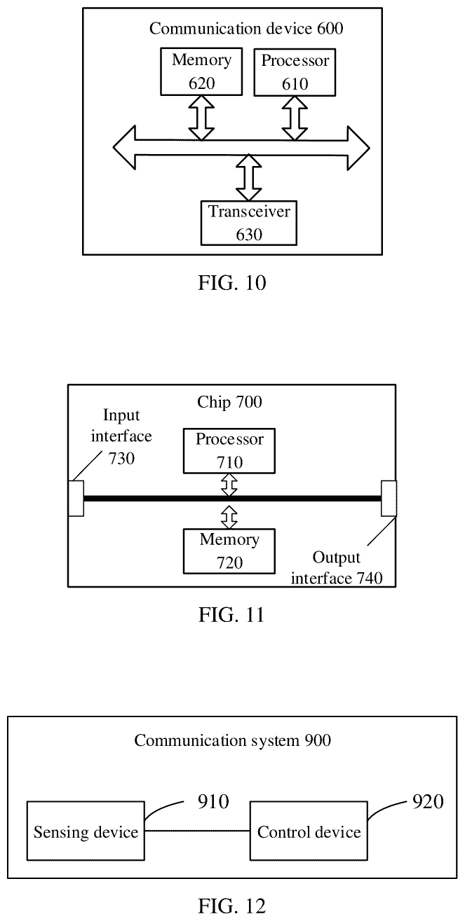

FIG. 10 is a schematic structural diagram of a communication device 600 provided in the embodiments of the present application. The communication device 600 shown in FIG. 10 includes a processor 610, and the processor 610 may invoke and execute a computer program from a memory to implement the methods in the embodiments of the present application.

Optionally, as shown in FIG. 10, the communication device 600 may further include a memory 620. The processor 610 may invoke and execute a computer program from the memory 620 to implement the methods in the embodiments of the present application.

Herein, the memory 620 may be a separate device independent from the processor 610, or may be integrated into the processor 610.

Optionally, as shown in FIG. 10, the communication device 600 may further include a transceiver 630, and the processor 610 may control the transceiver 630 to communicate with other devices, specifically, to send information or data to other devices, or receive information or data sent from other devices.

Herein, the transceiver 630 may include a transmitter and a receiver. The transceiver 630 may further include an antenna, and a number of antennas may be one or more.

Optionally, the communication device 600 may specifically be the network device in the embodiments of the present application, and the communication device 600 may implement corresponding procedures implemented by the network device in respective methods in the embodiments of the present application, which will not be repeated herein for the sake of brevity.

Optionally, the communication device 600 may specifically be the mobile terminal/terminal device of the embodiments of the present application, and the communication device 600 may implement corresponding procedures implemented by the mobile terminal/terminal device in respective methods in the embodiments of the present application, which will not be repeated herein for the sake of brevity.

FIG. 11 is a schematic structural diagram of a chip in the embodiments of the present application. The chip 700 shown in FIG. 11 includes a processor 710, and the processor 710 may invoke and execute a computer program from a memory to implement the methods in the embodiments of the present application.

In some embodiments, the memory may be included in the chip, or may not be included in the chip.

Optionally, as shown in FIG. 11, the chip 700 may further include a memory 720. The processor 710 may invoke and execute a computer program from the memory 720 to implement the methods in the embodiments of the present application.

The memory 720 may be a separate device independent from the processor 710, or may be integrated into the processor 710.

Optionally, the chip 700 may further include an input interface 730. The processor 710 may control the input interface 730 to communicate with other devices or chips, and specifically, to acquire information or data sent from other devices or chips.

Optionally, the chip 700 may further include an output interface 740. The processor 710 may control the output interface 740 to communicate with other devices or chips, and specifically, to output information or data to other devices or chips.

Optionally, the chip may be applied to the network device in the embodiments of the present application, and the chip may implement corresponding procedures implemented by the network device in respective methods in the embodiments of the present application, which will not be repeated herein for the sake of brevity.

Optionally, the chip may be applied to the mobile terminal/terminal device in the embodiments of the present application, and the chip may implement corresponding procedures implemented by the mobile terminal/terminal device in respective methods in the embodiments of the present application, which will not be repeated herein for the sake of brevity.

It should be understood that the chip mentioned in the embodiments of the present application may also be referred to as a system-level chip, a system chip, a chip system or a system-on-chip chip, etc.

FIG. 12 is a schematic block diagram of a communication system 900 provided in the embodiments of the present application. As shown in FIG. 12, the communication system 900 includes a sensing device 910 and a control device 920.

The sensing device 910 may be used to implement corresponding functions implemented by the sensing device in the above-mentioned methods, and the control device 920 may be used to implement corresponding functions implemented by the control device in the above-mentioned methods, which will not be repeated herein for the sake of brevity.

It should be understood that the processor in the embodiments of the present application may be an integrated circuit chip with signal processing capabilities. In the implementation process, respective steps of the above method embodiments can be completed by an integrated logic circuit of hardware in a processor or an instruction in software form. The above-mentioned processor may be a general-purpose processor, a Digital Signal Processor (DSP), an Application Specific Integrated Circuit (ASIC), a Field Programmable Gate Array (FPGA) or other programmable logic devices, a discrete gate or a transistor logic device, or a discrete hardware component. Various methods, steps and logical block diagrams disclosed in the embodiments of the present application may be implemented or performed. A general-purpose processor may be a microprocessor, or the processor may also be any conventional processor, etc. The steps of the method disclosed in combination with the embodiments of the present application may be directly embodied as being performed and completed by a hardware decoding processor, or by using a combination of hardware and software modules in the decoding processor. The software module may be located in the mature storage medium in the art such as the random memory, the flash memory, the read-only memory, the programmable read-only memory or erasable programmable memory, the register. The storage medium is located in the memory, and the processor reads the information in the memory and completes the steps of the above methods in combination with its hardware.

It may be understood that, the memory in the embodiments of the present application may be a volatile memory or a non-volatile memory, or may include both volatile and non-volatile memories. Herein, the non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a Random Access Memory (RAM), which is used as an external cache. Through illustrative, rather than limiting, illustration, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct Rambus random access memory (Direct Rambus RAM, DR RAM). It should be noted that, the memory of the system and the method described herein is intended to include, but not limited to, these and any other suitable types of memories.

It should be understood that, the above memory is exemplary but not the limited illustration, e.g., the memory in embodiments of the present application may also be a static Random Access Memory (static RAM, SRAM), a dynamic Random Access Memory (dynamic RAM, DRAM), a synchronous dynamic Random Access Memory (synchronous DRAM, SDRAM), a double data rate synchronous dynamic Random Access Memory (double data rate SDRAM, DDR SDRAM), an enhanced synchronous dynamic Random Access Memory (enhanced SDRAM, ESDRAM), a synch link dynamic Random Access Memory (synch link DRAM, SLDRAM), and a Direct Rambus Random Access Memory (Direct Rambus RAM, DR RAM), etc. That is, the memory in the embodiments of the present application is intended to include, but not limited to, these and any other suitable types of memories.

The embodiments of the present application further provide a non-transitory computer-readable storage medium for storing a computer program.

Optionally, the non-transitory computer-readable storage medium may be applied to the sensing device in the embodiments of the present application, and the computer program causes a computer to execute the corresponding processes implemented by the sensing device in respective methods in the embodiments of the present application, which will not be repeated herein for the sake of brevity.

Optionally, the non-transitory computer-readable storage medium may be applied to the control device in the embodiments of the present application, and the computer program causes a computer to execute the corresponding processes implemented by the control device in respective methods in the embodiments of the present application, which will not be repeated herein for the sake of brevity.

The embodiments of the present application further provide a computer program product, which includes a computer program instruction.

Optionally, the computer program product may be applied to the sensing device in the embodiments of the present application, and the computer program instruction causes a computer to execute the corresponding processes implemented by the sensing device in respective methods in the embodiments of the present application, which will not be repeated herein for the sake of brevity.

Optionally, the computer program product may be applied to the control device in the embodiments of the present application, and the computer program instruction causes a computer to execute the corresponding processes implemented by the control device in respective methods in the embodiments of the present application, which will not be repeated herein for the sake of brevity.

The embodiments of the present application further provide a computer program.

Optionally, the computer program may be applied to the sensing device in the embodiments of the present application. When the computer program is executed on a computer, the computer is caused to execute the corresponding processes implemented by the sensing device in respective methods in the embodiments of the present application, which will not be repeated herein for the sake of brevity.

Optionally, the computer program may be applied to the control device in the embodiments of the present application. When the computer program is executed on a computer, the computer is caused to execute the corresponding processes implemented by the control device in respective methods in the embodiments of the present application, which will not be repeated herein for the sake of brevity.

Those ordinary skilled in the art may realize that, units and algorithm steps of the examples described in combination with the embodiments disclosed herein can be implemented in electronic hardware or in a combination of computer software and electronic hardware. Whether these functions are performed by way of hardware or software depends on a specific application and a design constraint of the technical solution. A skilled person may use different methods for each specific application, to implement the described functions, but such implementation should not be considered beyond the scope of the embodiments of the present application.

It may be clearly understood by those skilled in the art that, for convenience and brevity of the description, specific working procedures of the system, the apparatus and the unit described above may refer to the corresponding procedures in the above method embodiments, which will not be repeated here.

In the several embodiments provided by the application, it should be understood that, the disclosed systems, apparatus, and method may be implemented in other ways. For example, the apparatus embodiments described above are only schematic, for example, the division of the units is only the division of logical functions, and there may be other division methods in an actual implementation, for example, a plurality of units or components may be combined or integrated into another system, or some features may be ignored or not be performed. On the other hand, the coupling or direct coupling or communicative connection with each other as shown or discussed may be indirect coupling or communicative connection of apparatus or units via some interfaces, which may be electrical, mechanical, or in other forms.

The units illustrated as separate components may be or may not be physically separated, and the components shown as units may be or may not be physical units, that is, they may be located in one place, or may also be distributed among a plurality of network units. A part or all of the units may be selected according to actual needs, to implement the purpose of the solutions of the embodiments.

In addition, various functional units in the various embodiments of the present application may be integrated into one processing unit, or the various units may physically exist separately, or two or more units may be integrated into one unit.

If the described functions are implemented in a form of a software functional unit and sold or used as an independent product, they may be stored in a computer readable storage medium. Based on this understanding, the technical solution of the embodiments of the present application essentially, or a part of the technical solution that contributes to the prior art, or a part of the technical solution, may be embodied in a form of a software product, and the computer software product is stored in a storage medium, and includes a plurality of instructions for enabling a computer device (which may be a personal computer, a server, or a network device, etc.) to perform all or some of steps of the methods described in the various embodiments of the present application. And, the storage medium mentioned above includes various mediums that may store program codes, such as a USB flash drive (U disk), a mobile hard disk, a read-only memory (ROM), a random access memory (RAM), a diskette, or an optical disk, etc.

The above is only a specific implementation of the present application, but the protection scope of the present application is not limited thereto, and any skilled familiar with this technical field may easily think of changes or substitutions within the technical scope disclosed in the present application, which should be all covered within the protection scope of the present application. Therefore, the protection scope of the present application should be subject to the protection scope of claims.

What is claimed is:

1. A method for wireless sensing, comprising:
determining, by a sensing device, a sensing result according to a plurality of sensing signals; wherein
the plurality of sensing signals are received by the sensing device by adopting a first receiving manner, or the sensing result is determined by the sensing device based on a first processing manner; the first receiving manner comprises not performing waveform adjusting on a sensing signal, or the first receiving manner comprises performing waveform adjusting on a sensing signal by adopting a first waveform adjustment parameter, and the first processing manner is used for the sensing device to perform waveform correction processing on the plurality of sensing signals.

2. The method according to claim 1, wherein the first waveform adjustment parameter is carried in first information.

3. The method according to claim 2, wherein the first information is further used to determine a physical resource for receiving a sensing signal and/or sequence information of the sensing signal.

4. The method according to claim 1, wherein receiving time of the plurality of sensing signals is within a first time window, wherein receiving manners for sensing signals with receiving time within the first time window are the first receiving manner.

5. The method according to claim 4, wherein a position of the first time window is predefined; or the position of the first time window is configured through a signaling;
or
a position of the first time window is determined according to a time domain position of at least one sensing signal of the plurality of sensing signals; wherein
the position of the first time window is determined according to a time domain position of a first sensing signal of the plurality of sensing signals, and the first sensing signal is a sensing signal of the plurality of sensing signals with earliest receiving time.

6. The method according to claim 4, wherein
a receiving manner adopted for receiving a sensing signal within the first time window is predefined; or
the receiving manner adopted for receiving the sensing signal within the first time window is configured through a signaling; or
the receiving manner adopted for receiving the sensing signal within the first time window is determined according to a position of the first time window; or,
the receiving manner adopted for receiving the sensing signal within the first time window is a receiving manner used by the sensing device at a starting moment or before the starting moment of the first time window.

7. The method according to claim 6, wherein the receiving manner adopted for receiving the sensing signal within the first time window being determined according to the position of the first time window, comprises:
the receiving manner adopted for receiving the sensing signal within the first time window being determined according to the position of the first time window and a mapping relationship, wherein the mapping relationship comprises a mapping relationship between a time window and a receiving manner for receiving the sensing signal; wherein
the mapping relationship is predefined, or configured through a signaling.

8. The method according to claim 6, wherein the method further comprises:
receiving, by the sensing device, a plurality of sensing signals by adopting a second receiving manner within a second time window, wherein the second receiving manner comprises not performing waveform adjusting on a sensing signal, or the second receiving manner comprises performing waveform adjusting on the sensing signal by adopting a second waveform adjustment parameter; wherein
the first waveform adjustment parameter is the same as the second waveform adjustment parameter; or
the first waveform adjustment parameter is different from the second waveform adjustment parameter.

9. The method according to claim 1, wherein in a case where the plurality of sensing signals are received by the sensing device by adopting the first receiving manner, determining, by the sensing device, the sensing result according to the plurality of sensing signals, comprises:
determining a plurality of pieces of auxiliary sensing information according to the plurality of sensing signals; and
determining the sensing result according to the plurality of pieces of auxiliary sensing information.

10. The method according to claim 1, wherein the sensing result is determined by the sensing device based on the first processing manner; and
determining, by the sensing device, the sensing result according to the plurality of sensing signals, comprises:
performing waveform correction processing on the plurality of sensing signals according to a waveform adjustment parameter adopted for receiving the plurality of sensing signals;
determining a plurality of pieces of auxiliary sensing information according to a plurality of sensing signals after the waveform correction processing is performed; and
determining the sensing result according to the plurality of pieces of auxiliary sensing information.

11. The method according to claim 1, wherein the sensing result is determined by the sensing device based on the first processing manner; and
determining, by the sensing device, the sensing result according to the plurality of sensing signals, comprises:
determining a plurality of pieces of auxiliary sensing information according to the plurality of sensing signals;
performing waveform correction processing on the plurality of pieces of auxiliary sensing information according to a waveform adjustment parameter adopted for receiving the plurality of sensing signals; and
determining the sensing result according to the plurality of pieces of auxiliary sensing information after the waveform correction processing is performed.

12. The method according to claim 9, wherein the auxiliary sensing information comprises at least one of: channel state information, latency estimation information, or frequency offset estimation information.

13. The method according to claim 1, wherein the sensing signal is a reflected signal of a signal sent from the sensing device, or the sensing signal is sent from other devices.

14. The method according to claim 1, wherein the first waveform adjustment parameter comprises at least one of the following parameters:
an automatic gain control (AGC) adjustment parameter, a carrier frequency offset (CFO) adjustment parameter, or a sampling frequency offset (SFO) adjustment parameter.

15. A method for wireless sensing, comprising:
sending, from a control device, first configuration information to a sensing device, wherein the first configuration information is used to configure a receiving manner adopted for the sensing device to receive a sensing signal, and the receiving manner comprises not performing waveform adjusting on the sensing signal, or performing waveform adjusting on the sensing signal by adopting a waveform adjustment parameter.

16. The method according to claim 15, wherein the first configuration information is used to configure a first waveform adjustment parameter.

17. The method according to claim 15, wherein the first configuration information is used to configure at least one of:
information of at least one time window; and
a receiving manner adopted for receiving the sensing signal within the at least one time window.

18. The method according to claim 17, wherein the information of the at least one time window comprises at least one of:
a starting position of the at least one time window, a length of the at least one time window, and a period of the at least one time window; wherein
the at least one time window comprises a first time window and a second time window, a receiving manner for receiving a sensing signal within the first time window is a first receiving manner, and a receiving manner for receiving a sensing signal within the second time window is a second receiving manner;
the first receiving manner comprises not performing waveform adjusting on the sensing signal, or the first receiving manner comprises performing waveform adjusting on the sensing signal by adopting a first waveform adjustment parameter; the second receiving manner comprises not performing waveform adjusting on the sensing signal, or the second receiving manner comprises performing waveform adjusting on the sensing signal by adopting a second waveform adjustment parameter; and the first waveform adjustment parameter is the same as or different from the second waveform adjustment parameter.

19. The method according to claim 15, wherein the method further comprises:
sending, from the control device, second configuration information, wherein the second configuration information is used to determine a physical resource for receiving the sensing signal and/or sequence information of the sensing signal.

20. A sensing device, comprising:
a processing unit, configured to determine a sensing result according to a plurality of sensing signals; wherein
the plurality of sensing signals are received by the sensing device by adopting a first receiving manner, or the sensing result is determined by the sensing device based on a first processing manner; the first receiving manner comprises not performing waveform adjusting on the sensing signal, or the first receiving manner comprises performing waveform adjusting on the sensing signal by adopting a first waveform adjustment parameter, and the first processing manner is used for the sensing device to perform waveform correction processing on the plurality of sensing signals.
